(19) United States
(12) Patent Application Publication
(10) Pub. No.: US 2010/0182371 A1
(43) Pub. Date: Jul. 22, 2010

(54) INK-JET RECORDING APPARATUS

(75) Inventor: Suguru Tomoguchi, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/691,468

(22) Filed: Jan. 21, 2010

(30) Foreign Application Priority Data
Jan. 21, 2009 (JP) 2009-010587

(51) Int. Cl. B41J 2/165

(52) U.S. Cl. 347/32

(57) ABSTRACT

An ink-jet recording apparatus, including: an ink-jet head; a conveyor mechanism having a conveyor surface and configured to convey the recording medium in a conveyance direction; a cap for covering the ejection surface; a cap moving mechanism configured to move the cap in a direction parallel to the conveyance direction such that the cap is placed at a retracted position where the cap does not face the ejection surface or a facing position where the cap faces the ejection surface; and a controller configured to control the cap moving mechanism such that a first motion in which the cap is moved from the retracted position to the facing position is conducted and to control the conveyor mechanism such that a second motion in which the conveyor surface is moved in the direction in which the cap is moved is conducted with the first motion, where a prescribed condition is satisfied.

### CROSS REFERENCE TO RELATED APPLICATION

The present application claims priority from Japanese Patent Application No. 2009-010587, which was filed on Jan. 21, 2009, the disclosure of which is herein incorporated by reference in its entirety.

### BACKGROUND OF THE INVENTION

1. Field of the Invention

The present invention relates to an ink-jet recording apparatus configured to conduct recording on a recording medium.

2. Discussion of Related Art

In a recording apparatus such as an ink-jet printer having an ink-jet head for ejecting ink on a recording medium such as a paper that is conveyed by a conveyor mechanism, an ejection surface of the ink-jet head in which ejection holes are formed is covered during a non-printing period, for the purpose of preventing the ejection holes from being clogged with ink, dusts, and the like.

For covering the ejection surface with the cap, there is disclosed a technique in which a maintenance mechanism equipped with a cap is configured to be horizontally moved in a clearance between the ink-jet head and the conveyor mechanism in a direction parallel to a medium conveyance direction in which the recording medium is conveyed.

### SUMMARY OF THE INVENTION

In a state in which the recording medium is present between the ink-jet head and the conveyor mechanism, if the cap is horizontally moved in the clearance between the ink-jet head and the conveyor mechanism in the direction parallel to the medium conveyance direction for covering the ejection surface with the cap, the recording medium and the cap may interfere with each other, causing a jam of the recording medium. In this case, the jammed recording medium may damage the ink-jet head and the conveyor mechanism. Further, where the jammed recording medium is present between the ink-jet head and the conveyor mechanism, the jammed recording medium and the cap may interfere with each other when the ejection surface is covered with the cap, so that the jammed recording medium may be placed in a worsened state, causing damage to the ink-jet head and the conveyor mechanism. Moreover, where foreign substances or objects are present between the ink-jet head and the conveyor mechanism, the foreign substances are moved by interference with the cap when the ejection surface is covered with the cap, so that the foreign substances may damage the ink-jet head and the conveyor mechanism.

It is therefore an object of the invention to provide an ink-jet recording apparatus capable of preventing an ink-jet head and a conveyor mechanism from being damaged when an ejection surface of the ink-jet head is covered with a cap.

The above-indicated object may be attained according to a principle of the invention, which provides an ink-jet recording apparatus, comprising:

an ink-jet head in which is formed an ejection surface from which ink is ejected;

a conveyor mechanism which has a conveyor surface configured to be opposed to the ejection surface and to support a recording medium thereon and which is configured to convey the recording medium in a medium conveyance direction by moving the conveyor surface;

a cap capable of covering the ejection surface;

a cap moving mechanism configured to move the cap in a direction parallel to the medium conveyance direction in a clearance between the ink-jet head and the conveyor mechanism such that the cap is placed selectively at one of a retracted position at which the cap does not face the ejection surface and a facing position at which the cap faces the ejection surface; and

a controller configured to control the cap moving mechanism such that a first motion in which the cap is moved from the retracted position to the facing position is conducted and to control the conveyor mechanism such that a second motion in which the conveyor surface is moved in the direction in which the cap is moved is conducted with the first motion, where a prescribed condition is satisfied.

### BRIEF DESCRIPTION OF THE DRAWINGS

The above and other objects, features, advantages and technical and industrial significance of the present invention will be better understood by reading the following detailed description of preferred embodiments of the invention, when considered in connection with the accompanying drawings, in which:

FIG. 1 is a perspective external view of an ink-jet printer according to one embodiment of the invention;

FIG. 2 is a schematic side view showing an internal structure of the ink-jet printer of FIG. 1;

FIG. 3 is a plan view of four ink-jet heads shown in FIG. 2 and the vicinity thereof when viewed from the above;

FIG. 4 is a schematic side view showing an up/down moving mechanism;

FIGS. 5A and 5B are perspective views showing a maintenance mechanism;

FIGS. 6A-6C are side views showing a capping operation;

FIG. 7 is a diagram showing an electrical structure of the ink-jet printer;

FIG. 8 is a view showing a capping routine;

FIG. 9 is a view showing a jam-clearing routine;

FIG. 10 is a view showing a routine for detecting a jam at a conveyor portion;

FIG. 11 is a side view showing a part of an internal structure of an ink-jet printer according to a second embodiment of the invention;

FIG. 12 is a view showing a capping routine implemented in another embodiment; and

FIG. 13 is a view showing a jam-clearing routine implemented in another embodiment.

### DETAILED DESCRIPTION OF THE PREFERRED EMBODIMENTS

There will be hereinafter described preferred embodiments of the invention with reference to the drawings.

### 1. First Embodiment

### Mechanical Structure of Ink-Jet Printer

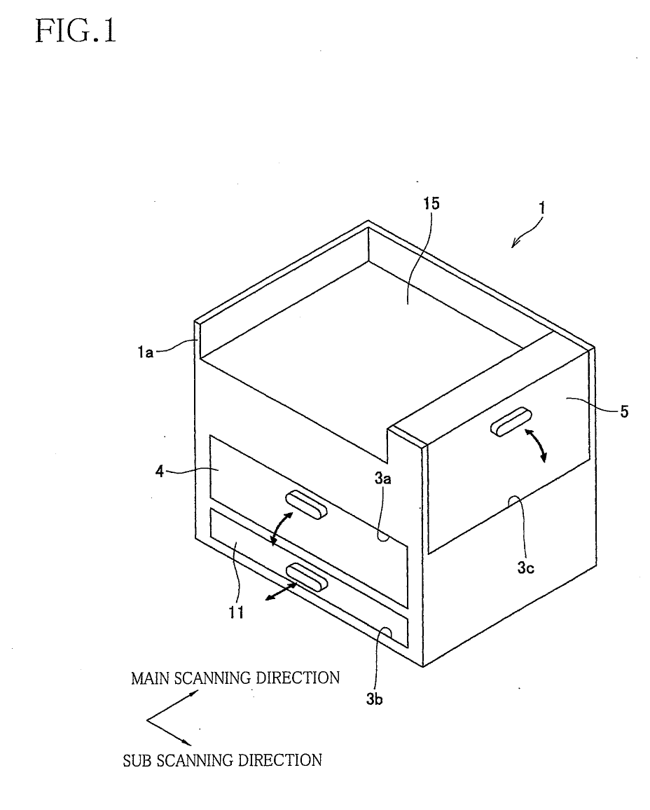

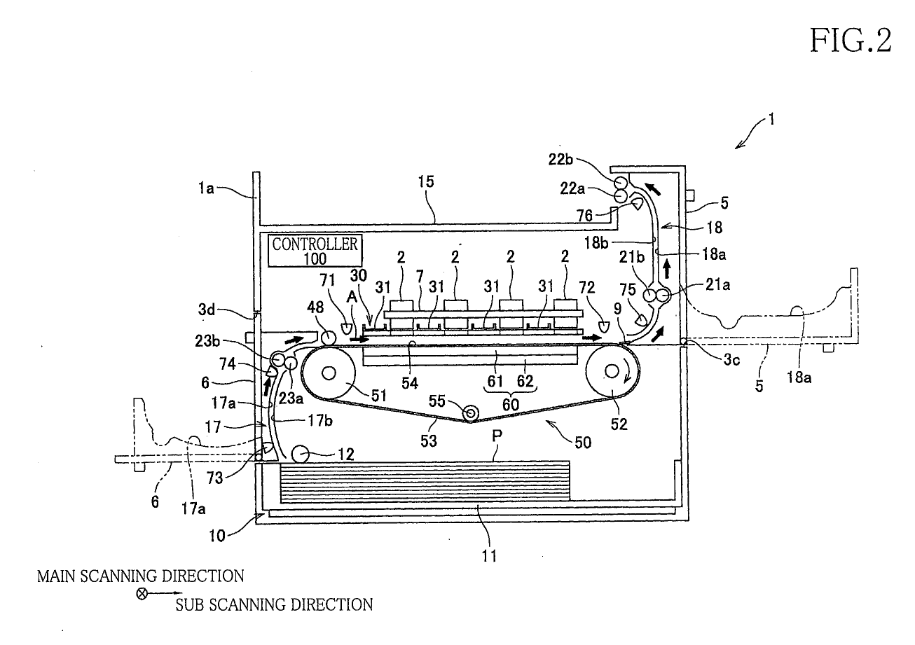

As shown in the perspective view of FIG. 1, an ink-jet printer 1 as an ink-jet recording apparatus according to one embodiment of the invention has a casing 1a which is a rectangular parallelepiped and which has two openings, i.e., upper and lower openings 3a, 3b, that are formed on the front of the casing 1a (on the front surface of the casing 1a in FIG. 1). In the opening 3a, a first door 4 is provided so as to be openable and closable about a horizontal axis located at the lower end of the opening 3a. The opening 3a and the first door 4 are disposed so as to be opposed to a conveyor mechanism 50 (a conveyor portion) in a depth direction of the casing 1a, namely, in a direction perpendicular to the sheet plane of FIG. 2, i.e., in a main scanning direction. The arrangement allows a user easy access to the conveyor mechanism 50 by opening the first door 4 in an instance where a sheet P (as a recording medium) is jammed in the conveyor mechanism 50, so that the jammed sheet P can be removed.

As shown in FIG. 1, an opening 3c is formed on one side surface of the casing 1a (on the right side surface of the casing 1a in FIG. 1). In the opening 3c, a third door 5 is provided so as to be openable and closable about a horizontal axis located at the lower end of the opening 3c. As shown in FIG. 2, on the inner side of the third door 5, an outer guide surface 18a that partially constitutes a sheet guide 18 (which will be described) is formed. The opening 3c and the third door 5 are disposed so as to be opposed to an inside of the sheet guide 18 in a sub scanning direction that is perpendicular to the main scanning direction. In this structure, where the sheet P is jammed in the sheet guide 18, the user can access the inside of the sheet guide 18 by opening the third door 5, so that the jammed sheet P can be removed.

An opening 3d (not shown) is formed on another side surface of the casing 1 (on the left side surface of the casing 1a in FIG. 1). In the opening 3d, a second door 6 is provided so as to be openable and closable about a horizontal axis located at the lower end of the opening 3d. As shown in FIG. 2, on the inner side of the second door 6, an outer guide surface 17a that partially constitutes a sheet guide 17 (which will be described) is formed. The opening 3d and the second door 6 are disposed so as to be opposed to an inside of the sheet guide 17 in the sub scanning direction. In this structure, where the sheet P is jammed in the sheet guide 17, the user can access the inside of the sheet guide 17 by opening the second door 6, so that the jammed sheet P can be removed.

The ink-jet printer 1 is a color ink-jet printer having four ink-jet heads 2 which respectively eject inks of different colors, i.e., magenta, cyan, yellow, and black. The ink-jet printer 1 has a sheet supply device 10 at its lower portion and a discharged-sheet receiving portion 15 at its upper portion. The conveyor mechanism 50 for conveying the sheet P in a sheet conveyance direction “A” shown in FIG. 2 (as a medium conveyance direction) is disposed between the sheet supply device 10 and the discharged-sheet receiving portion 15. The ink-jet printer 1 further has a controller 100 for controlling operations thereof.

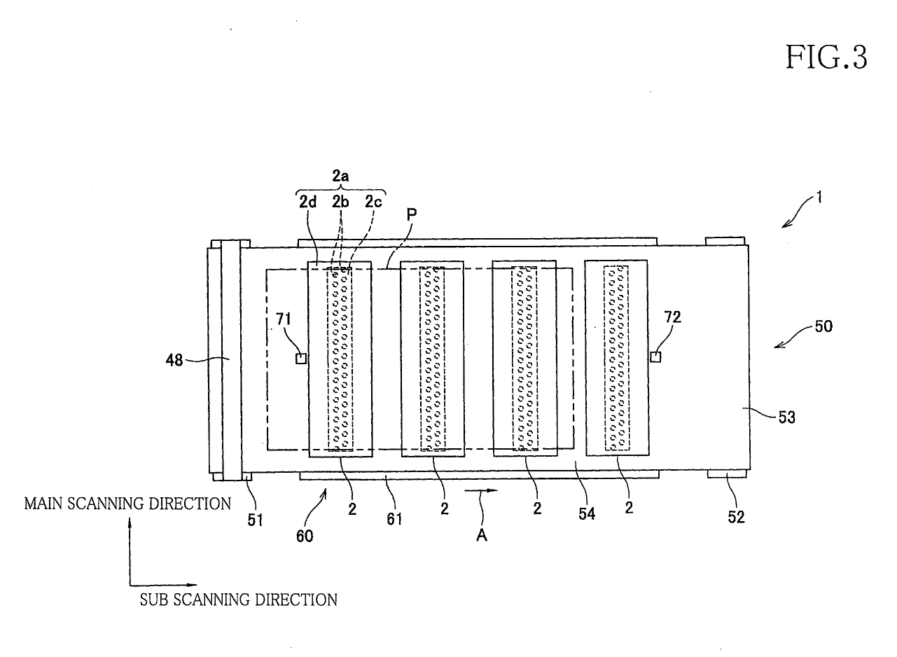

Each of the four ink-jet heads 2 has a generally rectangular parallelepiped shape that is long in the main scanning direction. The four ink-jet heads 2 are disposed so as to be spaced apart from each other in the sub scanning direction and are fixed to a frame 7. That is, the ink-jet printer 1 is a line-type printer. In the present embodiment, the sub scanning direction is a direction parallel to the sheet conveyance direction A while the main scanning direction is a direction perpendicular to the sub scanning direction and is horizontal, namely, the main scanning direction coincides with the vertical direction in FIG. 3.

Each ink-jet head 2 has a laminar body having; a flow-passage unit in which are formed ink passages that include pressure chambers; and an actuator for giving pressure to ink in the pressure chambers. The flow-passage unit and the actuator (both not shown) are bonded to each other so as to provide the laminar body. The bottom surface of each ink-jet head 2 is formed as an ejection surface 2a from which the ink is ejected. As shown in FIG. 3, the ejection surface 2a has a plurality of ejection holes 2b from which the ink is ejected, an ejection area 2c within which the ejection holes 2b are disposed, and a non-ejection area 2d which surrounds the ejection area 2c. The ejection area 2c has a dimension as measured in the main scanning direction that is slightly larger than the dimension of the sheet P as measured in the same direction. Accordingly, it is possible to form an image over an entire surface of the sheet P conveyed by the conveyor mechanism 50, namely, it is possible to conduct marginless printing. In FIG. 3, a maintenance mechanism 30 (which will be explained) is not shown.

As shown in FIG. 2, the sheet supply device 10 includes a sheet cassette 11 in which a stack of sheets P can be accommodated, a sheet supply roller 12 configured to supply an uppermost one of the sheets P from the sheet cassette 11, and a sheet supply motor (not shown) configured to rotate the sheet supply roller 12. The sheet cassette 11 is disposed so as to be attachable to and detachable from the casing 1a in a direction perpendicular to the sheet plane of FIG. 2. In a state in which the sheet cassette 11 is installed on the casing 1a, the sheet cassette 11 overlaps the conveyor mechanism 50 when viewed from the top of the printer 1. The sheet supply roller 12 is configured to supply the uppermost one of the sheets P from the sheet cassette 11 while being held in rolling contact therewith. The sheet supply motor configured to rotate the sheet supply roller 12 is controlled by the controller 100.

At the left-side portion of the ink-jet printer 1 as seen in FIG. 2, namely, at a portion of a sheet transfer path between the sheet cassette 11 and the conveyor mechanism 50, there are disposed: the sheet guide 17 which extends in a curved form from the sheet cassette 11 toward the conveyor mechanism 50; and two feed rollers 23a, 23b provided on the downstream side of the sheet guide 17. The sheet guide 17 is constituted by the outer guide surface 17a formed on the second door 6 and an inner guide surface 17b opposed to the outer guide surface 17a. The feed roller 23b is rotatably driven by a feed motor (not shown) controlled by the controller 100 while the feed roller 23a is a driven roller configured to be rotated as the sheet is transferred.

In the structure described above, the sheet supply roller 12 is rotated clockwise in FIG. 2 by being controlled by the controller 100, whereby the sheet P contacting the sheet supply roller 12 is transferred upward in FIG. 2 through the sheet guide 17. The sheet P is supplied to the conveyor mechanism 50 while being held by the feed rollers 23a, 23b.

A sensor 73 is disposed at a position which is downstream of the sheet supply roller 12 and is upstream of the sheet guide 17 while a sensor 74 is disposed at a position which is downstream of the sheet guide 17 and is upstream of the feed rollers 23a, 23b. Each of the sensors 73, 74 is disposed such that its detecting surface is opposed to the sheet P passing through the sheet guide 17. Each sensor 73, 74 is an optical sensor of reflection type configured to detect the sheet P by sensing a light reflected on the surface of the sheet P. The two sensors 73, 74 are disposed at the respective positions at which the two sensors 73, 74 are opposed to the inner central portion of the sheet guide 17 in the main scanning direction. These two sensors 73, 74 are configured to detect the leading end of the sheet P passing through the sheet guide 17. It is noted that each sensor 73, 74 is not limited to the optical sensor of reflection type, but may be an optical sensor of transmission type.

In an instance where the sensor 74 does not detect the leading end of the sheet P even though a prescribed time has been passed after detection of the leading end of the sheet P by the sensor 73, the controller 100 judges that a jam of the sheet P (so-called paper jam) has occurred in the sheet guide 17. In this instance, the controller 100 stops rotation of the sheet supply roller 12 and the feed roller 23b.

As shown in FIG. 2, the conveyor mechanism 50 includes two belt rollers 51, 52, an endless conveyor belt 53 wound around the two belt rollers 51, 52 so as to be stretched therebetween, a tension roller 55 configured to give tension to the conveyor belt 53, a feed motor (not shown) configured to rotate the belt roller 52, and an adhesion device 60. The two belt rollers 51, 52 are arranged along the sheet conveyance direction indicated A. As shown in FIG. 3, the conveyor belt 53 is opposed to the ejection surfaces 2a and has an outer circumferential surface functioning as a conveyor surface 54 on which the sheet P is held or supported. The two belt rollers 51, 52 and the feed motor constitute a drive mechanism for rotating the conveyor belt 53.

The belt roller 52 is a drive roller and is configured to be rotated clockwise in FIG. 2 by a feed motor (not shown). The belt roller 51 is a driven roller configured to be rotated clockwise in FIG. 2 by the movement of the conveyor belt 53 in accordance with the rotation of the belt roller 52. As shown in FIG. 2, the tension roller 55 is rotatably supported by the casing 1a so as to give tension to the conveyor belt 53 while contacting the inner circumferential surface of the conveyor belt 53 at the lower portion of the loop of the same 53. The tension roller 55 is configured to be rotated clockwise in FIG. 2 by the movement of the conveyor belt 53.

As shown in FIG. 2, the adhesion device 60 is disposed in a region enclosed by the conveyor belt 53 and includes a platen 61 having a generally rectangular parallelepiped shape and a fan 62 disposed below the platen 61. On the upper surface of the platen 61, a plurality of holes (not shown) are formed through the thickness of the platen 61. The plurality of holes are distributed over the entirety of the area of the upper surface of the platen 61, which area is opposed to the conveyor belt 53. The platen 61 has a dimension as measured in the main scanning direction slightly larger than dimensions of the sheet P and the conveyor belt 53 as measured in the same direction.

As shown in FIG. 2, the upper surface of the platen 61 is held in contact with the inner circumferential surface of the conveyor belt 53 at the upper portion of the loop of the belt 53 so as to support the belt 53 from the inside of the loop. According to the arrangement, the conveyor belt 53 at the upper portion of the loop and the ejection surfaces 2a of the ink-jet heads 2 are opposed to each other so as to be parallel to each other, and there is formed a slight clearance between the ejection surfaces 2a and the conveyor surface 54 of the conveyor belt 53. The clearance partially constitutes the sheet transfer path.

The fan 62 has a generally rectangular parallelepiped shape shown in FIG. 2. The fan 62 is configured to suck in the air through suction ports (not shown) formed in its upper surface by rotation of rotary vanes provided in its inside. The fan 62 is controlled by the controller 100.

A pressing roller 48 is located on the upstream side of one of the four ink-jet heads 2 that is disposed on the most upstream side in the sheet conveyance direction A among the four ink-jet heads 2, so as to be opposed to the belt roller 51 with the conveyor belt 53 interposed therebetween. The pressing roller 48 is biased toward the conveyor surface 54 by an elastic member such as a spring (not shown) and is configured to press the sheet P supplied from the sheet supply device 10 onto the conveyor surface 54. The pressing roller 48 is a driven roller configured to be rotated in accordance with the rotary movement of the conveyor belt 53.

In this structure, the conveyor belt 53 rotates by rotation of the belt roller 52 clockwise in FIG. 2 under the control of the controller 100. In this instance, the belt roller 51, the tension roller 55, and the pressing roller 48 are also rotated by the rotary movement of the conveyor belt 53. Further, the fan 62 is driven under the control of the controller 100, so that the air is drawn into the suction ports formed in the fan 62 through all of the plurality of holes formed in the platen 61. According to the arrangement, the sheet P supplied from the sheet supply device 10 is conveyed in the sheet conveyance direction A while adhering to the conveyor surface 54. In the structure, when the sheet P conveyed by and held on the conveyor surface 54 of the conveyor belt 53 passes right below the four ink-jet heads 2, the ink-jet heads 2 controlled by the controller 100 eject the respective inks toward the sheet P, so that an intended color image is formed on the sheet P.

A sensor 71 is disposed at a position between the pressing roller 48 and the most upstream ink-jet head 2 in the sheet conveyance direction A while a sensor 72 is disposed at a position that is downstream of the most downstream ink-jet head 2 in the sheet conveyance direction A, such that the detecting surface of each of the sensors 71, 72 faces the conveyor surface 54. Each sensor 71, 72 is an optical sensor of reflection type configured to detect the sheet P by sensing a light reflected on the surface of the sheet P. The two sensors 71, 72 are disposed at respective positions at which the two sensors 71, 72 are opposed to the middle portion of the conveyor surface 54 in the main scanning direction. These two sensors 71, 72 are configured to detect the leading end of the sheet P conveyed by the conveyor belt 53. It is noted that each sensor 71, 72 is not limited to the optical sensor of reflection type, but may be an optical sensor of transmission type.

In an instance where the sensor 72 does not detect the leading end of the sheet P even though a prescribed time has been passed after detection of the leading end of the sheet P by the sensor 71, the controller 100 judges that a jam of the sheet P (so-called paper jam) has occurred at the conveyor mechanism 50. In this instance, the controller 100 stops rotation of the conveyor belt 53 and stops ejection of the inks from the respective ink-jet heads 2.

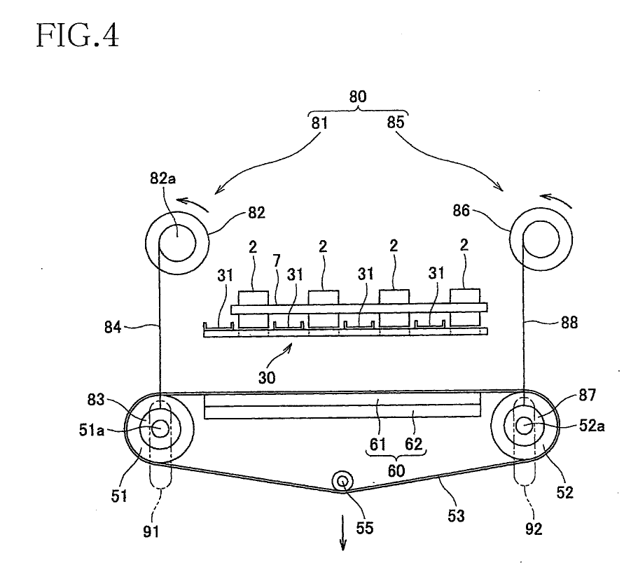

As shown in FIG. 4, the conveyor mechanism 50 is configured to be moved upward and downward relative to the ink-jet heads 2 by an up/down moving mechanism 80 as a relative movement mechanism between a recording position at which an image is recorded or printed on the sheet P with the inks ejected from the ink-jet heads 2 and a sheet removal position (as a medium removal position) at which a distance by which the ejection surfaces 2a and the conveyor mechanism 50 are spaced apart from each other is larger than that when the ink-jet heads 2 and the conveyor mechanism 50 are located at the recording position and at which a user is allowed to remove the sheet P when the sheet P is jammed between the ejection surfaces 2a and the conveyor mechanism 50. Each of the recording position and the sheet removal position is defined by relative positions of the ink-jet heads 2 and the conveyor mechanism 50. In other words, the conveyor mechanism 50 is moved upward and downward between the recording position shown in FIG. 2 at which the conveyor mechanism 50 is located close to the ink-jet heads 2 and the sheet removal position at which the conveyor mechanism 50 is located at a height level lower than the recording position.

As shown in FIG. 4, the up/down moving mechanism 80 includes an up/down moving portion 81 configured to move the belt roller 51 upward and downward and an up/down moving portion 85 configured to move the belt roller 52 upward and downward. The up/down moving portion 81 has an up/down motor 82, two rings 83, and wires 84 each as a connecting member. The rings 83 are disposed near respective opposite axial ends of a roller shaft 51a of the belt roller 51 and rotatably support the roller shaft 51a. Each wire 84 is fixed at one end thereof to the upper end of the corresponding ring 83 and is fixed to and wound around a motor shaft 82a of the up/down motor 82 at the other end thereof. At respective positions of the casing 1a facing the opposite axial ends of the roller shaft 51a of the belt roller 51, guides 91 are formed for guiding the opposite axial ends of the roller shaft 51a of the belt roller 51 when the belt roller 51 is moved upward and downward. Each guide 91 is formed such that its upper end coincides with the position of the roller shaft 51a at a time when the conveyor mechanism 50 is located at the recording position. The guide 91 extends downward from its upper end.

Similarly, the up/down moving portion 85 has an up/down motor 86, two rings 87, and wires 88 each as a connecting member. The rings 87 are disposed near respective opposite axial ends of a roller shaft 52a of the belt roller 52 and rotatably support the roller shaft 52a. Each wire 88 is fixed at one end thereof to the upper end of the corresponding ring 87 and is fixed to and wound around a motor shaft 86a of the up/down motor 86 at the other end thereof. At respective positions of the casing 1a facing the opposite axial ends of the roller shaft 52a of the belt roller 52, guides 92 are formed for guiding the opposite axial ends of the roller shaft 52a of the belt roller 52 when the belt roller 52 is moved upward and downward. Each guide 92 is formed such that its upper end coincides with the position of the roller shaft 52a at a time when the conveyor mechanism 50 is located at the recording position. The guide 92 extends downward from its upper end.

In the structure, when the two up/down motors 82, 86 are simultaneously driven under the control of the controller 100 and the motor shafts 82a, 86a are rotated counterclockwise in FIG. 4, the wires 84, 88 are unwound from the respective motor shafts 82a, 86a, whereby the conveyor mechanism 50 moves downward along the guides 91, 92. That is, the conveyor mechanism 50 is moved from the recording position to the sheet removal position. On the other hand, when the motor shafts 82a, 86a are rotated clockwise in FIG. 4 under the control of the controller 100, the wires 84, 88 are wound around the respective motor shafts 82a, 86a, whereby the conveyor mechanism 50 moves upward along the guides 91, 92. That is, the conveyor mechanism 50 is moved from the sheet removal position to the recording position.

The movement of the conveyor mechanism 50 from the recording position to the sheet removal position is conducted in an instance where a jam of the sheet P occurs at the conveyor mechanism 50 in a printing or recording operation in which an image is being printed or recorded on the sheet P with the conveyor mechanism 50 located at the recording position. When the conveyor mechanism 50 is located at the sheet removal position, the distance between the ejection surfaces 2a and the conveyor mechanism 50 is large, thereby allowing the user easy access to the conveyor mechanism 50 by opening the first door 4, so that the jammed sheet P can be easily removed.

While the conveyor mechanism 50 is configured to be moved upward and downward relative to the ink-jet heads 2 by the up/down moving mechanism 80 in the present embodiment, the ink-jet heads 2 may be configured to be moved upward and downward relative to the conveyor mechanism 50 by the up/down moving mechanism 80.

As shown in FIG. 2, a separation plate 9 is disposed on the immediately downstream side of the conveyor mechanism 50 in the sheet conveyance direction A. The separation plate 9 is configured to separate the sheet P from the conveyor surface 54 such that the edge of the separation plate 9 is inserted between the sheet P and the conveyor belt 53.

At a portion of the sheet transfer path between the conveyor mechanism 50 and the discharged-sheet receiving portion 15, there are disposed: four feed rollers 21a, 21b, 22a, 22b; and the sheet guide 18 located between the feed rollers 21a, 21b and the feed rollers 22a, 22b. The feed rollers 21b, 22b are rotatably driven by a feed motor (not shown) controlled by the controller 100. The feed rollers 21a, 22a are driven rollers configured to be rotated as the sheet is transferred. The sheet guide 18 is constituted by the outer guide surface 18a formed on the third door 5 and an inner guide surface 18b opposed to the outer guide surface 18a.

In the arrangement described above, the feed motor is driven under the control of the controller 100 so as to rotate the feed rollers 21b, 22b, whereby the sheet P conveyed by the conveyor mechanism 50 is transferred upward in FIG. 2 through the sheet guide 18 while being held by the feed rollers 21a, 21b. Subsequently, the sheet P is discharged to the discharged-sheet receiving portion 15 while being held by the feed rollers 22a, 22b.

A sensor 75 is disposed at a position which is downstream of the separation plate 9 and is upstream of the feed rollers 21a, 21b while a sensor 76 is disposed at a position which is downstream of the sheet guide 18 and is upstream of the feed rollers 22a, 22b. Each of the sensors 75, 76 is disposed such that its detecting surface is opposed to the sheet P passing through the sheet guide 18. Each sensor 75, 76 is an optical sensor of reflection type configured to detect the sheet P by sensing a light reflected on the surface of the sheet P. The two sensors 75, 76 are disposed at respective positions at which the two sensors 75, 76 are opposed to the inner central portion of the sheet guide 18 in the main scanning direction. These two sensors 75, 76 are configured to detect the leading end of the sheet P passing through the sheet guide 18. It is noted that each sensor 75, 76 is not limited to the optical sensor of reflection type, but may be an optical sensor of transmission type.

In an instance where the sensor 76 does not detect the leading end of the sheet P even though a prescribed time has been passed after detection of the leading end of the sheet P by the sensor 75, the controller 100 judges that a jam of the sheet P (so-called paper jam) has occurred in the sheet guide 18. In this instance, the controller 100 stops rotation of the feed rollers 21b, 22b

As shown in FIG. 2, the maintenance mechanism 30 (as a cap moving mechanism) is disposed between the four ink-jet heads 2 and the conveyor mechanism 50. The maintenance mechanism 30 has four caps 31 configured to cover the ejection surfaces 2a of the respective ink-jet heads 2. Each of the caps 31 is formed of an elastic material such as rubber and has a rectangular shape in plan view whose longitudinal direction is parallel to the longitudinal direction of each ink-jet head 2. Each cap 31 is located, in its initial state, on the immediately upstream side of the corresponding ink-jet head 2, and is moved, in accordance with the movement of the maintenance mechanism 30, in the leftward and rightward direction and in the upward and downward direction as seen in FIG. 2, relative to the corresponding ink-jet head 2.

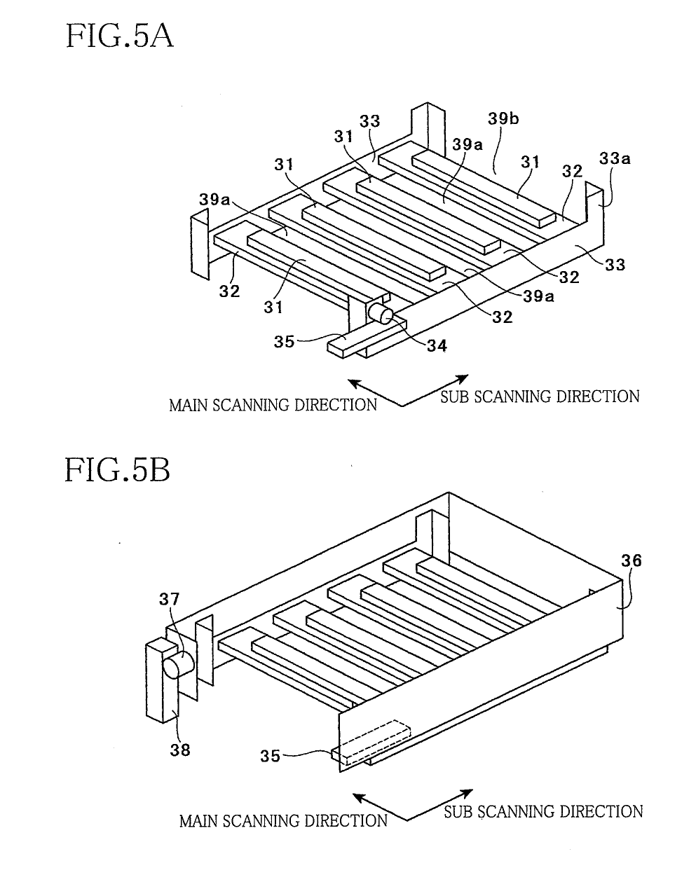

As shown in FIG. 5A, the maintenance mechanism 30 includes: four plate members 32 which are equally spaced apart from each other in the sub scanning direction and each of which has the cap 31 disposed on its upper surface; and a pair of inner frames 33 between which the plate members 32 are held. Each inner frame 33 has protruding corner portions 33a that extend upward at respective opposite ends thereof. On one corner portion 33a of each inner frame 33, a pinion gear 34 that is fixed to a shaft of a drive motor (not shown) is disposed so as to mesh with a rack gear 35 disposed horizontally. In FIG. 5A, the pinion gear 34 of only one of the inner frames 33 (that is located on the front side as seen in FIG. 5A) is shown.

As shown in FIG. 5B, the maintenance mechanism 30 further includes an outer frame 36 disposed so as to enclose the pair of inner frames 33. Inside the outer frame 36, the rack gear 35 shown in FIG. 5A is fixed. The outer frame 36 is provided with a pinion gear 37 that is fixed to a shaft of a drive motor (not shown). The pinion gear 37 is disposed so as to mesh with a rack gear 38 disposed vertically. The rack gear 38 is disposed so as to extend upright in the casing 1a.

In the arrangement described above, when the two pinion gears 34 are synchronously rotated, the inner frames 33 are moved in the sub scanning direction. Further, when the pinion gear 37 is rotated, the outer frame 36 is moved in the vertical direction.

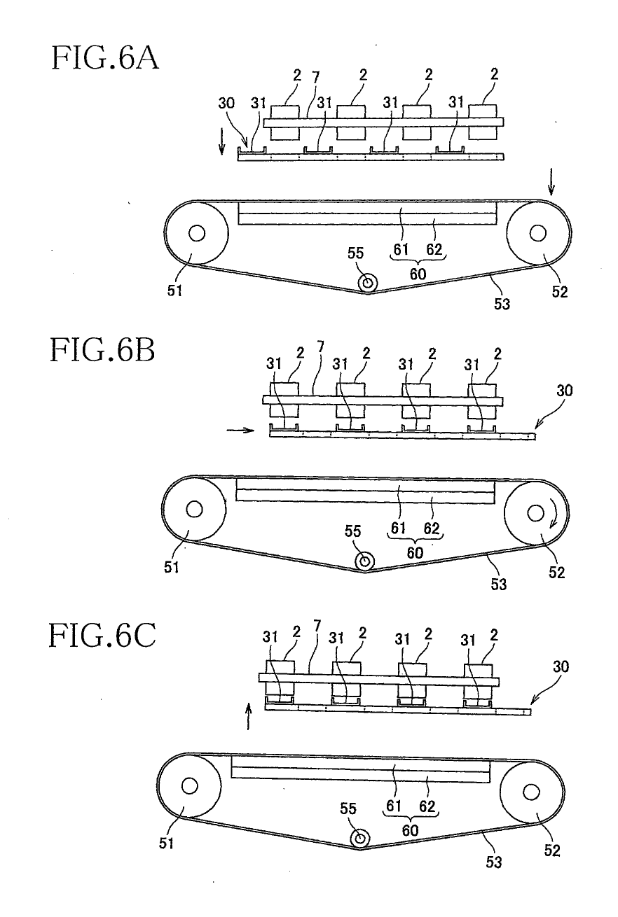

More specifically, when the maintenance mechanism 30 is located at an initial position shown in FIG. 2, each plate member 32 is located on the immediately upstream side of the corresponding ink jet head 2, and three openings 39a between any adjacent two plate members 32 and one opening 39b between the plate member 32 located on the most downstream side and the corner portions 33a of the inner frame 33 are opposed to the respective ejection surfaces 2a. When a capping operation for covering the ejection surfaces 2a with the corresponding caps 31 is conducted, the outer frame 36 is moved downward in the vertical direction, so that the maintenance mechanism 30 is moved to an intervening position at which the maintenance mechanism 30 is located between the ink-jet heads 2 and the conveyor mechanism 50, as shown in FIG. 6A. On this occasion, the caps 31 are located at a retracted position at which the caps 31 are not opposed to the ejection surfaces 2a.

Thereafter, the pair of inner frames 33 are moved downstream in the sub scanning direction, as shown in FIG. 6B. On this occasion, the caps 31 are located at a facing position at which the caps 31 face the corresponding ejection surfaces 2a. Then the outer frame 36 is moved upward in the vertical direction, whereby the caps 31 are located at a capping position at which the caps 31 contact the corresponding ejection surfaces 2a so as to cover the same 2a, as shown in FIG. 6C. According to this procedure, the ejection surfaces 2a are covered with the respective caps 31. The caps 31 return back to the initial position by conducting the procedure in a reverse order.

The capping operation described above is conducted with the conveyor mechanism 50 located at the sheet removal position after having been moved downward from the recording position by the up/down moving mechanism 80 or with the conveyor mechanism 50 located at the recording position. Further, the capping operation is conducted in an instance where a jam of the sheet P occurs at any of the sheet guide 17, the sheet guide 18, and the conveyor mechanism 50.

Here, in synchronism with the movement of the caps 31 from the retracted position to the facing position shown in FIG. 6B, the conveyor belt 53 is rotated clockwise in FIG. 6B, whereby the conveyor surface 54 is moved in the direction in which the caps 31 are moved.

In synchronism with the movement of the caps 31 from the retracted position to the facing position, the conveyor belt 53 is rotated clockwise in FIG. 6B, namely, the conveyor belt 53 is rotated in the same direction as the direction of the movement of the caps 31. Accordingly, the conveyor surface 54 is moved in the same direction as the direction of the movement of the caps 31. In the arrangement, even if the sheet P is present between the ink-jet heads 2 and the conveyor mechanism 50, the sheet P is moved in the same direction as the direction of the movement of the caps 31 at the same speed as the speed of the movement of the caps by the same distance as the distance by which the caps 31 are moved, thereby avoiding a jam of the sheet P due to interference thereof with the caps 31. Further, even if a jammed sheet P is present between the ink-jet heads 2 and the conveyor mechanism 50, the jammed sheet P is moved in the same direction as the direction of the movement of the caps 31, so as to prevent the jammed sheet P from being placed in a worsen state due to interference thereof with the caps 31. Moreover, even if the foreign substances or objects are present between the ink-jet heads 2 and the conveyor mechanism 50, the foreign substances or objects are moved in the same direction as the direction of the movement of the caps 31, thereby preventing interference of the foreign substance or objects with the caps 31. Thus, it is possible to prevent the ink-jet heads 2 and the conveyor mechanism 50 from being damaged when the ejection surfaces 2a are covered with the caps 31.

In an instance where a jam of the sheet P occurs at the conveyor mechanism 50 when an image is being recorded on the sheet P with the conveyor mechanism located at the recording position, the conveyor mechanism 50 is moved downward from the recording position to the sheet removal position by the up/down moving mechanism 80, as shown in FIG. 6A. Subsequently, in synchronism with the movement of the caps 31 from the retracted position to the facing position, the conveyor surface 54 is moved in the same direction as the direction of the movement of the caps 31, as shown in FIG. 6B.

Thus, in an instance where a jam of the sheet P has occurred between the ink-jet heads 2 and the conveyor mechanism 50, the conveyor mechanism 50 is moved relative to the ink-jet heads 2 from the recording position to the sheet removal position. At the same time when or after the conveyor mechanism 50 is thus moved, the caps 31 are moved from the retracted position to the facing position and the conveyor surface 54 is moved in the same direction as the direction of the movement of the caps 31 in synchronism with the movement of the caps 31, so that the jammed sheet P is moved in the same direction as the direction of the movement of the caps 31, thereby preventing the jammed sheet P from being placed in a worsened state due to interference thereof with the caps 31. Therefore, the ink-jet heads 2 and the conveyor mechanism 50 are prevented from being damaged by the jammed sheet P when the ejection surfaces 2 are covered with the caps 31.

Further, the adhesion device 60 is controlled by the controller 100 so as to be placed in its operating state for permitting the sheet P existing between the ink-jet heads 2 and the conveyor mechanism 50 to adhere to the conveyor surface 54 in a state in which the caps 31 are being moved from the retracted position to the facing position and the conveyor surface 54 is being moved in the same direction as the direction of the movement of the caps 31. According to the arrangement, in an instance where the sheet P is present between the ink-jet heads 2 and the conveyor mechanism 50, the sheet P is permitted to adhere to the conveyor surface 54, whereby the sheet P can be moved with high reliability in the same direction as the direction of the movement of the caps 31.

### <Electric Structure of Ink-Jet Printer>

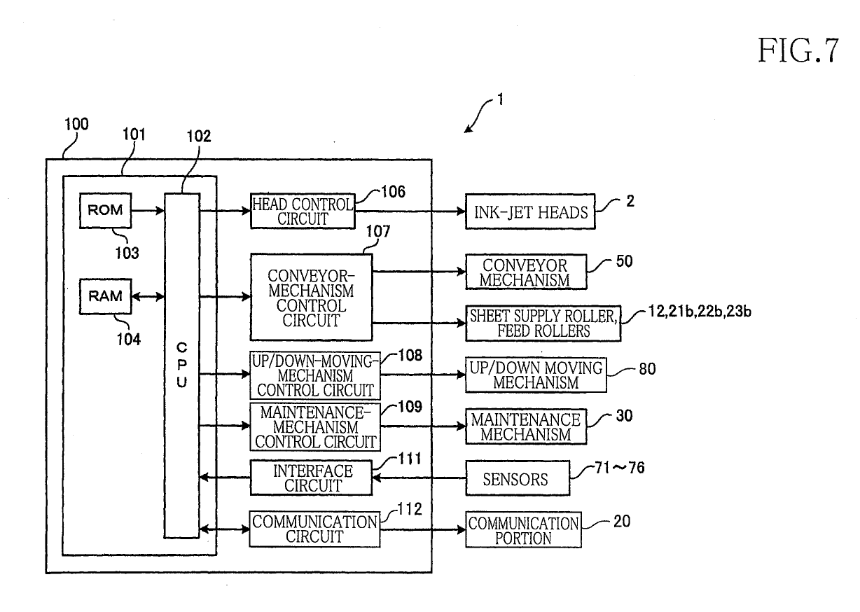

The operations of the ink-jet printer 1 are controlled by the controller 100, as shown in FIG. 7. The controller 100 is constituted by a microcomputer 101 as its main constituent element disposed on a circuit board, and various circuits. The microcomputer 101 includes a CPU 102 for controlling various operations according to preset programs, a ROM 103 for storing various programs, and a RAM 104 as a temporary memory device.

To the CPU 102, there are connected: a head control circuit 106 for controlling the ink-jet heads 2; a conveyor-mechanism control circuit 107 for controlling the conveyor mechanism 50, the feed rollers 21b, 22b, 23b, and the sheet supply roller 12; an up/down-moving-mechanism control circuit 108 for controlling the up/down moving mechanism 80; a maintenance-mechanism control circuit 109 for controlling the maintenance mechanism 30; an interface circuit 111 to which sheet detection signals from the sensors 71-76 are inputted; and a communication circuit 112 for performing communication with a general-purpose personal computer (not shown) or the like via a communication portion 20.

The head control circuit 106 is configured to control the ink-jet heads 2 to eject the inks toward the sheet P, on the basis of recording or printing data transmitted from the personal computer or the like via the communication portion 20. On this occasion, the head control circuit 106 controls the ink-jet heads 2 to start ejection of the inks toward the sheet P a predetermined time after the sensor 71 has detected the leading end of the sheet P conveyed by the conveyor mechanism 50. The above-indicated predetermined time is equal to a time obtained by dividing a distance, along the sheet transfer path, between the position of the leading end of the sheet P when the sensor 71 detects the leading end and the position of the ejection holes 2b which are located most upstream in the most upstream one of the four ink-jet heads 2, by a speed at which the sheet P is transferred.

The conveyor-mechanism control circuit 107 is configured to control the conveyor mechanism 50, the feed rollers 21b, 22b, 23b, and the sheet supply roller 12 such that the sheet P is transferred from the sheet supply device 10 to the discharged-sheet receiving portion 15. In particular, the conveyor-mechanism control circuit 107 as a controller is configured to control the conveyor mechanism 50 such that a second motion in which the conveyor surface 54 is moved in the same direction as the direction of the movement of the caps 31 is conducted in synchronism with a first motion (that will be explained) where a condition (as a prescribed condition) for conducing the capping operation is satisfied. Further, the conveyor-mechanism control circuit 107 when functioning as the controller is configured to control the adhesion device 60 so as to permit the sheet P to adhere to the conveyor surface 54 in the second motion.

The up/down-moving-mechanism control circuit 108 is configured to control the up/down moving mechanism 80 such that the conveyor mechanism 50 is moved away from the ink-jet heads 2 when a jam of the sheet P that is being conveyed has occurred, for instance. In particular, the up/down-moving-mechanism control circuit 108 as the controller is configured to control the up/down moving mechanism 80 such that, where jam of the sheet P has occurred between the ink-jet heads 2 and the conveyor mechanism 50, a third motion in which the conveyor mechanism 50 is moved relative to the ink-jet heads 2 from the recording position to the sheet removal position is conducted concurrently with or prior to the first motion and the second motion.

The maintenance-mechanism control circuit 109 is configured to control the maintenance mechanism 30 to conduct the capping operation when a jam of the sheet P that is being conveyed occurs. In particular, the maintenance-mechanism control circuit 109 as the controller is configured to control the maintenance mechanism 30 such that the first motion in which the caps 31 are moved from the retracted position to the facing position is conducted where the condition (as the prescribed condition) for conducing the capping operation is satisfied.

The CPU 102 judges that a jam of the sheet P has occurred only when a time interval of detection of the sheet P by the two sensors in each of the three sets of sensors, i.e., the sensors 71 and 72, the sensors, 73 and 74, and the sensors 75 and 76, exceeds respective preset values. In other words, the CPU 102 judges that a jam of the sheet P has occurred in an instance where the downstream-side sensor of each set does not detect the leading end of the sheet P before a prescribed time elapses after detection of the leading end of the sheet P by the upstream-side sensor of the set. The prescribed time is equal to a time obtained by diving the distance between the two sensors in each set along the sheet transfer path, by the sheet transfer speed.

More specifically, the CPU 102 initially judges that a jam of the sheet P has occurred in the sheet guide 17 in an instance where the sensor 74 does not yet detect the leading end of the sheet P at an expected time point at which the prescribed time has elapsed from the time point of detection of the leading end of the sheet P by the sensor 73, namely, in an instance where the sensor 74 does not detect the leading end of the sheet P before the prescribed time elapses after detection of the leading end of the sheet P by the sensor 73. Here, the prescribed time is equal to a time obtained by dividing the distance between the sensor 73 and the sensor 74, by the sheet transfer speed. That is, the CPU 102 detects an occurrence of the sheet jam in the sheet guide 17. The CPU 102 next judges that a jam of the sheet P has occurred at the conveyor mechanism 50 in an instance where the sensor 72 does not detect the leading end of the sheet P before the prescribed time elapses after detection of the leading end of the sheet P by the sensor 71. Here, the prescribed time is equal to a time obtained by dividing the distance between the sensor 71 and the sensor 72, by the sheet transfer speed. That is, the CPU 102 when functioning as a detecting device with the sensors 71, 72 judges an occurrence of the sheet jam between the ink-jet heads 2 and the conveyor mechanism 50. The CPU 102 then judges that a jam of the sheet P has occurred in the sheet guide 18 in an instance where the sensor 76 does not detect the leading end of the sheet P before the prescribed time elapses after detection of the leading end of the sheet P by the sensor 75. Here, the prescribed time is equal to a time obtained by dividing the distance between the sensor 75 and the sensor 76, by the sheet transfer speed. That is, the CPU 102 detects an occurrence of the sheet jam in the sheet guide 18.

The head control circuit 106 and the conveyor-mechanism control circuit 107 stop ejection of the ink from each ink-jet head 2 and stop conveyance of the sheet P by the conveyor mechanism 50 where the CPU 102 judges that the sheet jam has occurred. Where the time interval of detection of the sheet P by the two sensors in each of the three sets of sensors is held within the prescribed time and the CPU 102 does not judge the occurrence of the sheet jam, the inks are ejected to the sheet P in a state in which the ink-jet heads 2 are opposed to the sheet P, whereby an image is formed on the sheet P. The image-formed sheet P is discharged onto the discharged-sheet receiving portion 15.

### <Operations of the Ink-Jet Printer>

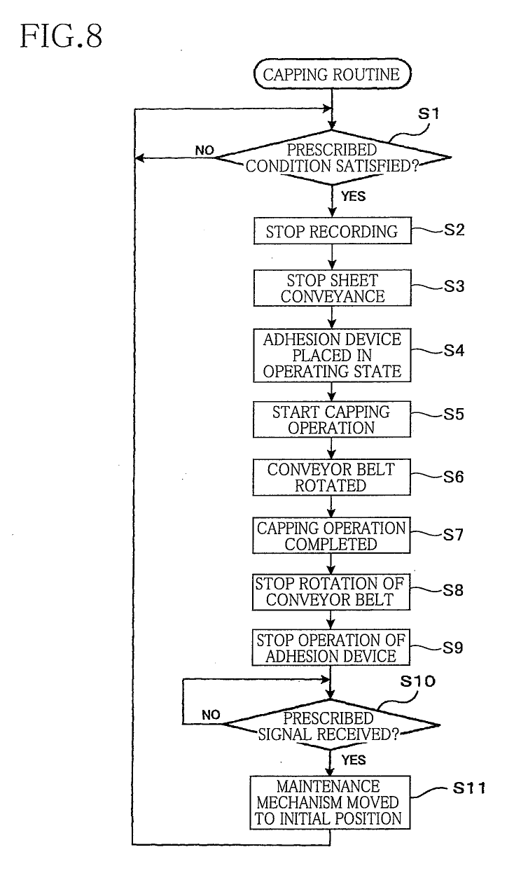

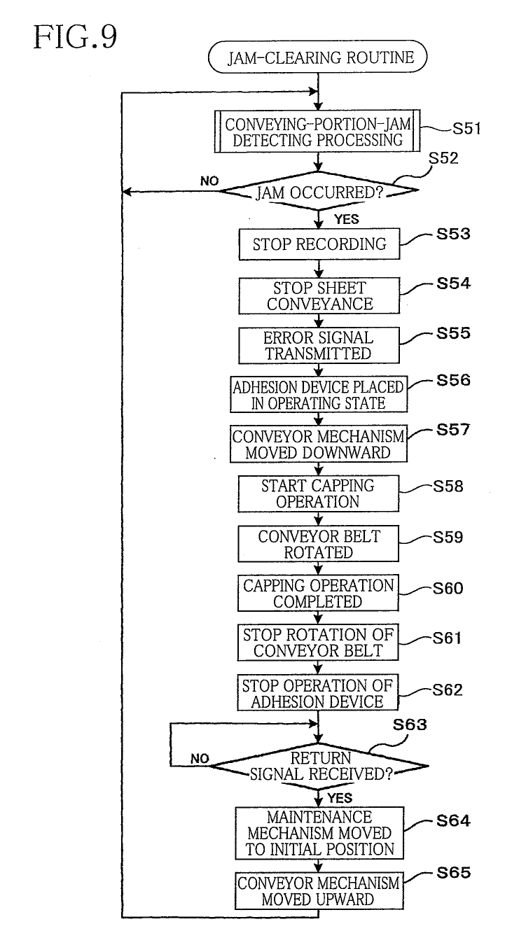

There will be next explained operations of the thus constructed ink-jet printer 1 referring to a capping routine shown in FIG. 8 and a jam-clearing routine shown in FIG. 9. The jam-clearing routine of FIG. 9 is a routine for dealing with a sheet jam at the conveyor mechanism 50. Sheet jams in the sheet guides 17, 18 are dealt with according to respective routines, which are not explained here.

### <Capping Routine>

The capping routine shown in FIG. 8 starts with step S1 (hereinafter “step” is omitted where appropriate) in which it is judged whether the prescribed condition, namely, the condition for conducting the capping operation, has been satisfied or not. Here, the condition for conducting the capping operation specifically includes a state in which a jam of the sheet P has occurred, a state in which printing has not been conducted for a time period longer than a predetermined time, a state in which the power has been turned off, and so on. Where it is judged that the prescribed condition has not been satisfied, the control flow goes back to S1. On the other hand, where it is judged that the prescribed condition has been satisfied, S2 is implemented in which the head control circuit 106 controls the ink-jet heads 2 to stop recording. Then S3 is implemented in which the conveyor-mechanism control circuit 107 controls the conveyor mechanism 50, the feed rollers 21b, 22b, 23b, and the sheet supply roller 12 to stop conveyance or transfer of the sheet P.

S3 is followed by S4 in which the conveyor-mechanism control circuit 107 controls the conveyor mechanism 50 so as to place the adhesion device 60 in its operating state for permitting the sheet P to adhere to the conveyor surface 54 if the sheet P exists between the ink-jet heads 2 and the conveyor mechanism 50. S4 is followed by S5 in which the maintenance-mechanism control circuit 109 controls the maintenance mechanism 30 to start the capping operation, so that the caps 31 are moved from the retracted position to the facing position. Then S6 is implemented in which the conveyor-mechanism control circuit 107 controls the conveyor mechanism 50 to rotate the conveyor belt 53, whereby the conveyor surface 54 starts moving in the same direction as the direction of the movement of the caps 31.

Thus, in synchronism with the movement of the caps 31 from the retracted position to the facing position, the conveyor belt 53 is rotated clockwise in FIG. 6B, namely, the conveyor belt 53 is rotated in the same direction as the direction of the movement of the caps 31. Accordingly, the conveyor surface 54 is moved in the same direction as the direction of the movement of the caps 31. In the arrangement, even if the sheet P is present between the ink-jet heads 2 and the conveyor mechanism 50, the sheet P is moved in the same direction as the direction of the movement of the caps 31 at the same speed as the speed of the movement of the caps by the same distance as the distance by which the caps 31 are moved, thereby avoiding an occurrence of a jam of the sheet P due to interference thereof with the caps 31 and preventing the jam of the sheet P from becoming worse. Moreover, even if the foreign substances or objects are present between the ink-jet heads 2 and the conveyor mechanism 50, the foreign substances or objects are moved in the same direction as the direction of the movement of the caps 31, thereby preventing interference of the foreign substances or objects with the caps 31. Thus, it is possible to prevent the ink-jet heads 2 and the conveyor mechanism 50 from being damaged when the ejection surfaces 2a are covered with the caps 31.

In the arrangement described above, in a state in which the caps 31 are being moved from the retracted position the facing position and the conveyor surface 54 is being moved in the same direction as the direction of the movement of the caps 31, the adhesion device 60 is kept placed in its operating state. Accordingly, in an instance where the sheep P is present between the ink-jet heads 2 and the conveyor mechanism 50, the sheet P is permitted to adhere to the conveyor surface 54 by the adhesion device 60, whereby the sheet P can be moved in the same direction as the direction of the movement of the caps 31 with high reliability.

Subsequently, the capping operation is completed in S7, so that the ejection surfaces 2a are covered with the caps 31. Thereafter, the rotation of the conveyor belt 53 is stopped in S8 and the adhesion device 60 ceases to operate in S9. Then the user carries out the jam-clearing operation by opening the first door 4.

Thereafter, it is judged in S10 whether a prescribed signal has been received or not. Here, the prescribed signal is for giving a command to expose the ejection surfaces 2a that have been covered by the caps 31, for permitting the recording to be started. Where it is judged that the prescribed signal has not been received yet, S10 is repeatedly implemented until the prescribed signal is received. On the other hand, where it is judged that the prescribed signal has been received, S11 is implemented in which the maintenance-mechanism control circuit 109 controls the maintenance mechanism 30 such that the maintenance mechanism 30 returns back to the initial position. Then the control flow gees back to step S1.

### <Jam-Clearing Routine>

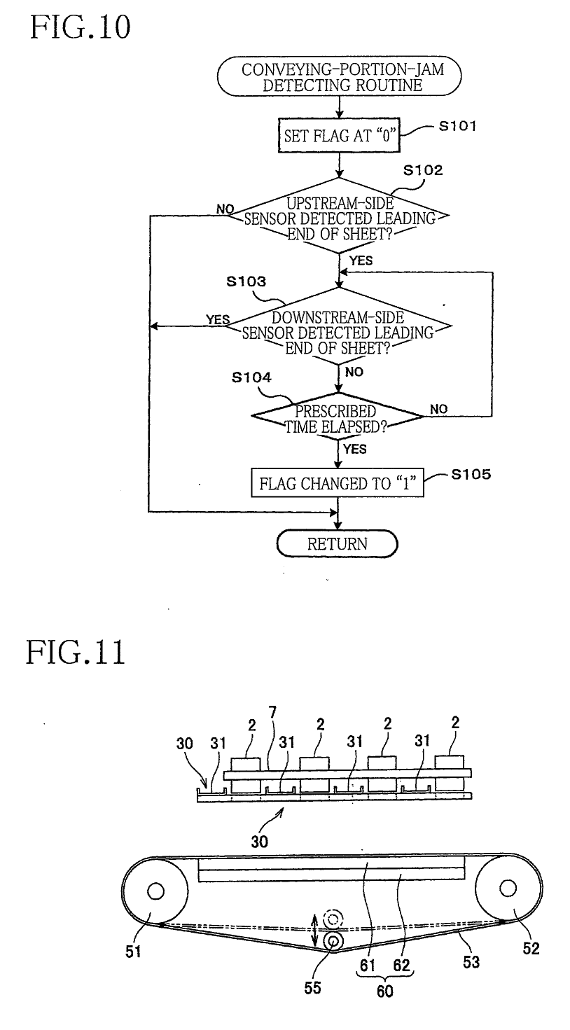

The jam-clearing routine shown in FIG. 9 starts with step S51 in which a conveyor-portion-jam detecting processing (that will be explained with reference to the routine of FIG. 10) is conducted. S51 is followed by S52 to judge whether a sheet jam has occurred at the conveyor mechanism 50. Where it is judged that the sheet jam has not occurred, the control flow goes back to S51. On the other hand, where it is judged that the sheet jam has occurred, S53 is implemented in which the head control circuit 106 controls the ink-jet heads 2 so as to stop recording and S54 is implemented in which the conveyor-mechanism control circuit 107 controls the conveyor mechanism 50, the feed rollers 21b, 22b, 23b, and the sheet supply roller 12 so as to stop conveyance or transfer of the sheet P. Then S55 is implemented in which an error signal is transmitted from the communication circuit 112 to the exterior via the communication portion 20.

Subsequently, S56 is implemented in which the conveyor-mechanism control circuit 107 controls the conveyor mechanism 50 to place the adhesion device 60 in its operating state for permitting the sheet P to adhere to the conveyor surface 54. S56 is followed by S57 in which the up/down-moving-mechanism control circuit 108 controls the up/down moving mechanism 80 to move the conveyor mechanism 50 downward, so that the conveyor mechanism 50 is located at the sheet removal position distant from the ink-jet heads 2. Then S58 is implemented in which the maintenance-mechanism control circuit 109 controls the maintenance mechanism 30 to start the capping operation, so that the caps 31 are moved from the retracted position to the facing position. Subsequently, S59 is implemented in which the conveyor-mechanism control circuit 107 controls the conveyor mechanism 50, whereby the conveyor belt 53 is rotated and the conveyor surface 54 starts moving in the same direction as the direction of the movement of the caps 31.

As described above, in an instance where a jam of the sheet P has occurred between the ink-jet heads 2 and the conveyor mechanism 50, the conveyor mechanism 50 is moved relative to the ink-jet heads 2 from the recording position to the sheet removal position. At the same time when or after the conveyor mechanism 50 is thus moved, the caps 31 are moved from the retracted position to the facing position and the conveyor surface 54 is moved in the same direction as the direction of the movement of the caps 31 in synchronism with the movement of the caps 31. Accordingly, the jammed sheet P is moved in the same direction as the direction of the movement of the caps 31, thereby preventing the jam that is occurring in the sheet P from becoming worse due to interference of the sheet P with the caps 31. Therefore, the ink-jet heads 2 and the conveyor mechanism 50 are prevented from being damaged by the jammed sheet P when the ejection surfaces 2 are covered with the caps 31.

Further, the adhesion device 60 is controlled to be placed in its operating state for permitting the sheet P existing between the ink-jet heads 2 and the conveyor mechanism 50 to adhere to the conveyor surface 54 in a state in which the caps 31 are being moved from the retracted position to the facing position and the conveyor surface 54 is being moved in the same direction as the direction of the movement of the caps 31. According to the arrangement, the sheet P can be moved with high reliability in the same direction as the direction of the movement of the caps 31.

S59 is followed by S60 in which the capping operation is completed, so that the ejection surfaces 2a are covered with the caps 31. Subsequently, the rotation of the conveyor belt 53 is stopped in S61 and the adhesion device 60 ceases to operate in S62. Then the user carries out the jam-clearing operation by opening the first door 4.

Thereafter, it is judged in S63 whether a return signal for allowing the maintenance mechanism 30 to return to the initial position after completion of the jam-clearing processing by the user has been received. Where it is judged that the return signal is not received yet, S63 is repeatedly implemented until the return signal is received. On the other hand, where it is judged that the return signal has been received, S64 is implemented in which the maintenance-mechanism control circuit 109 controls the maintenance mechanism 30 such that the maintenance mechanism 30 returns back to the initial position. S64 is followed by S65 in which the up/down-moving-mechanism control circuit 108 controls the up/down moving mechanism 80 to move the conveyor mechanism 50 upward, so that the conveyor mechanism 50 is located at the recording position near the ink-jet heads 2. Then the control flow goes back to S51.

<Conveyor-Portion-Jam detecting Routine>

With reference to FIG. 10, the conveyor-portion-jam detecting routine executed in S51 of the routine of FIG. 9 will be explained. As shown in FIG. 10, a flag is set at “0” in S101. The flag is used for judging in S52 of the routine of FIG. 9 whether the sheet jam has occurred or not. In an instance where the sheet jam has occurred, the flag is changed to “1”. That is, where the flag is “1”, it is judged that the sheet jam has occurred at the conveyor mechanism 50.

Subsequently, it is judged in S102 whether the upstream-side sensor 71 has detected the leading end of the sheet P. Where it is judged in S102 that the upstream-side sensor 71 has not yet detected the leading end of the sheet P, the sub routine is ended and the control flow goes back to the jam-clearing routine of FIG. 9.

On the other hand, where it is judged in S102 that the upstream-side sensor 71 has detected the leading end of the sheet P, it is judged in S103 whether the downstream-side sensor 72 has detected the leading end of the sheet P. Where it is judged in S103 that the downstream-side sensor 72 has detected the leading end of the sheet P, the sub routine is ended and the control flow goes back to the jam-clearing routine of FIG. 9.

On the other hand, where it is judged in S103 that the downstream-side sensor 72 has not yet detected the leading end of the sheet P, it is judged in S104 that the prescribed time has elapsed. Where it is judged in S104 that the prescribed time has not elapsed, the control flow goes back to S103. On the other hand, where it is judged in S104 that the prescribed time has elapsed, it is judged that the sheet jam has occurred, and the flag is changed from “0” to “1” in S105. Thus, the sub routine is ended and the control flow goes back to the jam-clearing routine of FIG. 9.

### 2. Second Embodiment

### Mechanical Structure of Ink-Jet Printer

Next, there will be explained an ink-jet printer according to a second embodiment with reference to FIG. 11. The ink-jet printer of the second embodiment differs from the ink-jet printer of the first embodiment in that the tension roller 55 is configured to be moved upward and downward by a moving device (not shown), as shown in FIG. 11.

The tension roller 55 is normally located at a position at which the tension roller 55 gives tension to the conveyor belt 53, as indicated by the solid line in FIG. 11. In the second embodiment, the tension roller 55 is configured to be moved up to a position indicated by the two-dot chain line in FIG. 11 to reduce a load for a rotary movement of the conveyor belt 53, i.e., a resistance against the rotary movement of the conveyor belt 53 relative to the two rollers 51, 52, when the capping operation is being conducted. According to the arrangement, in an instance where the sheet P is present between the ink-jet heads 2 and the conveyor mechanism 50, the conveyor belt 53 is moved in the same direction as the direction of the movement of the caps 31 as the sheet P is moved in the direction of the movement of the caps 31 by being pushed by the caps 31. In other words, the conveyor belt 53 is permitted to be moved by being pushed by the caps 31. Consequently, the sheet P is moved in the same direction as the direction of the movement of the caps 31. Therefore, no electric power is required for rotating or moving the conveyor belt 53. This is true of an instance where the foreign substances or objects are present between the ink-jet heads 2 and the conveyor mechanism 50. The ink-jet printer according to the second embodiment is identical with the ink-jet printer according to the first embodiment except for the structure described above, and its detailed explanation is dispensed with.

### <Operations of the Ink-Jet Printer>

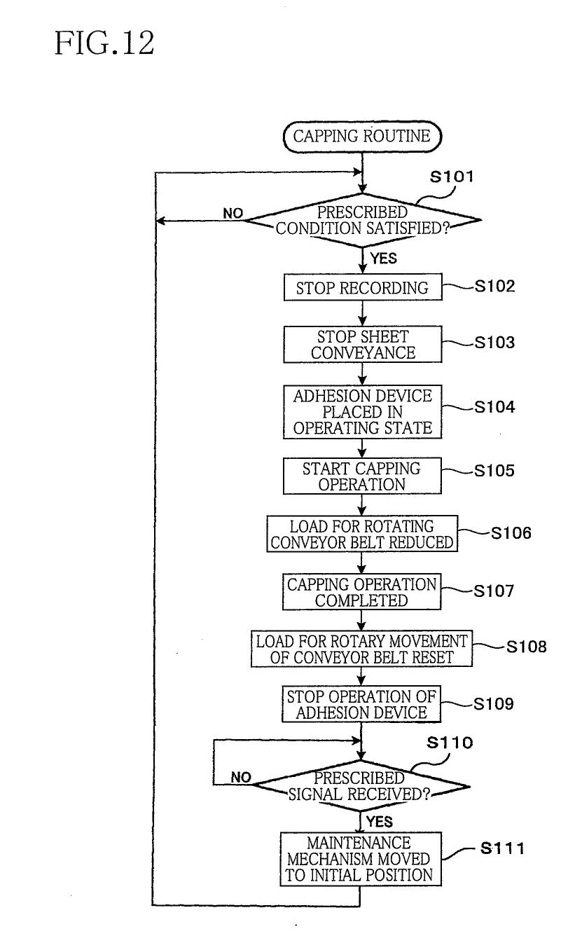

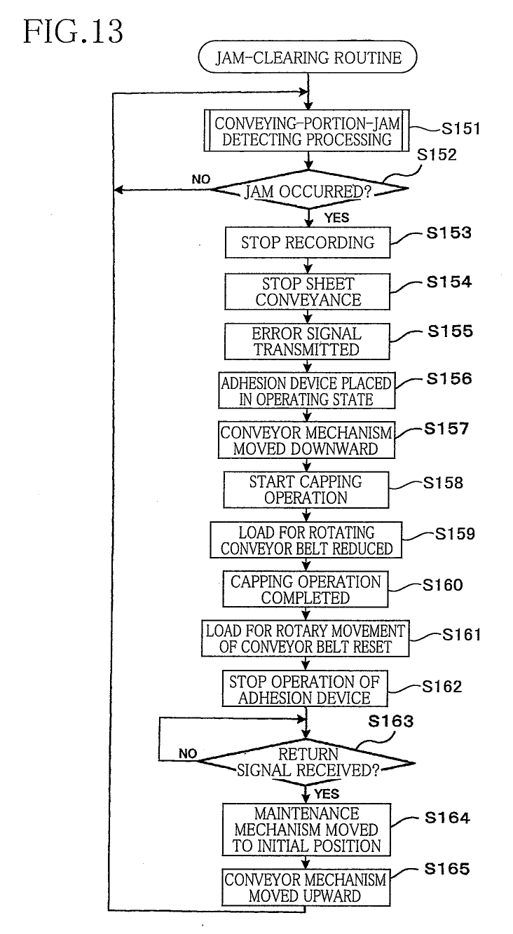

There will be next explained operations of the thus constructed ink-jet printer referring to a capping routine shown in FIG. 12 and a jam-clearing routine shown in FIG. 13.

### <Capping Routine>

The capping routine shown in FIG. 12 starts with step S101 in which it is judged whether the prescribed condition, namely, the condition for conducting the capping operation, has been satisfied or not. Where it is judged that the prescribed condition has not been satisfied, the control flow goes back to S101. On the other hand, where it is judged that the prescribed condition has been satisfied, S102 is implemented in which the head control circuit 106 controls the ink-jet heads 2 to stop recording. Then S103 is implemented in which the conveyor-mechanism control circuit 107 controls the conveyor mechanism 50, the feed rollers 21b, 22b, 23b, and the sheet supply roller 12 to stop conveyance or transfer of the sheet P. S103 is followed by S104 in which the conveyor-mechanism control circuit 107 controls the conveyor mechanism 50 so as to place the adhesion device 60 in its operating state for permitting the sheet P to adhere to the conveyor surface 54 if the sheet P exists between the ink-jet heads 2 and the conveyor mechanism 50. S104 is followed by S105 in which the maintenance-mechanism control circuit 109 controls the maintenance mechanism 30 to start the capping operation, so that the caps 31 are moved from the retracted position to the facing position. Then S106 is implemented in which the conveyor-mechanism control circuit 107 controls the conveyor mechanism 50 such that the tension roller 55 is moved upward, thereby reducing the load for the rotary movement of the conveyor belt 53.

In the ink-jet printer according to the second embodiment, the load for the rotary movement of the conveyor belt 53 can be reduced. Accordingly, even if the sheet P is present between the ink-jet heads 2 and the conveyor mechanism 50, the conveyor belt 53 is permitted to be moved in the same direction as the direction of the movement of the caps 31 when the sheet P is moved by being pushed by the caps 31. Consequently, the sheet P is moved in the direction of the movement of the caps 31. Accordingly, no electric power is required for rotating the conveyor belt 53. This is true of an instance where the foreign substance or object is present between the ink-jet heads 2 and the conveyor mechanism 50.

Subsequently, the capping operation is completed in S107, so that the ejection surfaces 2a are covered with the caps 31. Thereafter, the tension roller 55 is moved downward, so that the load for the rotary movement of the conveyor belt 53 is reset in S108 and the adhesion device 60 ceases to operate in S109. Then the user carries out the jam-clearing operation by opening the first door 4.

Thereafter, it is judged in S110 whether a prescribed signal has been received or not. Here, the prescribed signal is for giving a command to expose the ejection surfaces 2a that have been covered by the caps 31, for permitting recording to be started, for instance. Where it is judged that the prescribed signal has not been received yet, S110 is repeatedly implemented until the prescribed signal is received. On the other hand, where it is judged that the prescribed signal has been received, S111 is implemented in which the maintenance-mechanism control circuit 109 controls the maintenance mechanism 30 such that the maintenance mechanism 30 returns back to the initial position. Then the control flow gees back to step S101.

### <Jam-Clearing Routine>

The jam-clearing routine shown in FIG. 13 starts with step S151 in which the conveyor-portion-jam detecting processing explained above with respect to FIG. 10 is conducted. S151 is followed by S152 to judge whether a sheet jam has occurred at the conveyor mechanism 50. Where it is judged that the sheet jam has not occurred, the control flow goes back to S151. On the other hand, where it is judged that the sheet jam has occurred, S153 is implemented in which the head control circuit 106 controls the ink-jet heads 2 so as to stop recording and S154 is implemented in which the conveyor-mechanism control circuit 107 controls the conveyor mechanism 50, the feed rollers 21b, 22b, 23b, and the sheet supply roller 12 so as to stop conveyance or transfer of the sheet P. Then S155 is implemented in which an error signal is transmitted from the communication circuit 112 to the exterior via the communication portion 20.

Subsequently, S156 is implemented in which the conveyor-mechanism control circuit 107 controls the conveyor mechanism 50 to place the adhesion device 60 in its operating state for permitting the sheet P to adhere to the conveyor surface 54. S156 is followed by S157 in which the up/down-moving-mechanism control circuit 108 controls the up/down moving mechanism 80 to move the conveyor mechanism 50 downward, so that the conveyor mechanism 50 is located at the sheet removal position distant from the ink-jet heads 2. Then S158 is implemented in which the maintenance-mechanism control circuit 109 controls the maintenance mechanism 30 to start the capping operation, so that the caps 31 are moved from the retracted position to the facing position. Subsequently, S159 is implemented in which the conveyor-mechanism control circuit 107 controls the conveyor mechanism 50, whereby the tension roller 55 is moved upward and the load for the rotary movement of the conveyor belt 53 is reduced.

In the ink-jet printer according to the second embodiment, the load for the rotary movement of the conveyor belt 53 can be thus reduced. According to the arrangement, the conveyor belt 53 is permitted to be moved in the same direction as the direction of the movement of the caps 31 by the sheet that is present between the ink-jet heads 2 and the conveyor mechanism 50 and that is moved by being pushed by the caps 31. As a result, the sheet P is moved in the direction of the movement of the caps 31. Accordingly, no electric power is required for rotating the conveyor belt 53.

Subsequently, the capping operation is completed in S160, so that the ejection surfaces 2a are covered with the caps 31. Thereafter, the tension roller 55 is moved downward, so that the load for the rotary movement of the conveyor belt 53 is reset in S161 and the adhesion device 60 ceases to operate in S162. Then the user carries out the jam-clearing operation by opening the first door 4.

Thereafter, it is judged in S163 whether a return signal for allowing the maintenance mechanism 30 to return to the initial position after completion of the jam-clearing processing by the user has been received. Where it is judged that the return signal is not received yet, S163 is repeatedly implemented until the return signal is received. On the other hand, where it is judged that the return signal has been received, S164 is implemented in which the maintenance-mechanism control circuit 109 controls the maintenance mechanism 30 such that the maintenance mechanism 30 returns back to the initial position. S164 is followed by S165 in which the up/down-moving-mechanism control circuit 108 controls the up/down moving mechanism 80 to move the conveyor mechanism 50 upward, so that the conveyor mechanism 50 is located at the recording position near the ink-jet heads 2. Then the control flow goes back to S151.

### <Modifications>

While the presently preferred embodiments have been described, it is noted that the invention is not limited to the details of the illustrated embodiments, but may be embodied with various changes and modifications, which may occur to those skilled in the art, without departing from the spirit and scope of the invention defined in the attached claims. It is further noted that the effects of the invention described in the illustrated embodiments are preferable ones arising from the invention and that the effects of the invention are not limited to those described in the illustrated embodiments.

In the illustrated embodiments, the conveyor mechanism 50 may be configured to be moved downward from the recording position to the sheet removal position whenever the capping operation is conducted. To the contrary, the conveyor mechanism 50 may be configured not to be moved downward from the recording position to the sheet removal position whenever the capping operation is conducted.

In the illustrated first embodiment, the second motion in which the conveyor surface 54 is moved in the same direction as the direction of the movement of the cap 31 is conducted by the rotation of the conveyor belt 53. In the illustrated second embodiment, the second motion is conducted by the reduction of the load for the rotary movement of the conveyor belt 53. The second motion may be conducted otherwise. For instance, the conveyor surface 54 may be moved in the same direction as the direction of the movement of the caps 31 by a movement of the conveyor mechanism 50 per se in the same direction as the direction of the movement of the caps 31.

In the illustrated embodiments, the adhesion device 60 may be configured not to operate in the second motion in which the conveyor surface 54 is moved in the same direction as the direction of the movement of the caps 31.

The ink-jet recording apparatus according to the present invention is not limited to the ink-jet type, but may be applicable to a thermal type. Further, the ink-jet recording apparatus according to the present invention is not limited to the line type, but may be applicable to a serial type in which the heads are reciprocated. The principle of the invention may be applicable to not only the printer, but also a facsimile machine, a copying machine, and the like. While the conveyor mechanism 50 in the illustrated embodiments is configured to convey the sheet P in the horizontal direction, the conveyor mechanism 50 may be configured to convey the sheet P in directions other than the horizontal direction such as a direction inclined with respect to the horizontal direction, the vertical direction, etc., by arranging the conveyor surface 54 such that the conveyor surface 54 that is parallel to the ejection surfaces 2 is inclined or vertical with respect to the horizontal direction.

What is claimed is:

1. An ink-jet recording apparatus, comprising:
an ink-jet head in which is formed an ejection surface from which ink is ejected;
a conveyor mechanism which has a conveyor surface configured to be opposed to the ejection surface and to support a recording medium thereon and which is configured to convey the recording medium in a medium conveyance direction by moving the conveyor surface;
a cap capable of covering the ejection surface;
a cap moving mechanism configured to move the cap in a direction parallel to the medium conveyance direction in a clearance between the ink-jet head and the conveyor mechanism such that the cap is placed selectively at one of a retracted position at which the cap does not face the ejection surface and a facing position at which the cap faces the ejection surface; and
a controller configured to control the cap moving mechanism such that a first motion in which the cap is moved from the retracted position to the facing position is conducted and to control the conveyor mechanism such that a second motion in which the conveyor surface is moved in the direction in which the cap is moved is conducted with the first motion, where a prescribed condition is satisfied.

2. The ink-jet recording apparatus according to claim 1, wherein the conveyor mechanism has: a conveyor belt having one surface that functions as the conveyor surface; and a drive mechanism configured to move the conveyor belt.

3. The ink-jet recording apparatus according to claim 2, wherein the controller is configured to control the conveyor mechanism such that the second motion is a motion that is conducted by the movement of the conveyor belt by the drive mechanism, in synchronism with the first motion.

4. The ink-jet recording apparatus according to claim 2, wherein a speed at which the conveyor surface is moved in the second motion is the same as a speed at which the cap is moved in the first motion.

5. The ink-jet recording apparatus according to claim 2, wherein a distance by which the conveyor surface is moved in the second motion is the same as a distance by which the cap is moved in the first motion.

6. The ink-jet recording apparatus according to claim 2, wherein the controller is configured to control the conveyor mechanism such that a load for a movement of the conveyor belt is reduced for permitting the second motion to be conducted, the second motion being a motion in which a movement of the conveyor belt is permitted when the recording medium is pushed by the cap.

7. The ink-jet recording apparatus according to claim 1, further comprising:
a relative movement mechanism configured to move at least one of the conveyor mechanism and the ink-jet head relative to each other such that the conveyor mechanism and the ink-jet head are located selectively at one of (a) a recording position at which an image is recorded on the recording medium with the ink ejected from the ink-jet head and (b) a medium removal position at which a distance between the ejection surface and the conveyor mechanism is larger than that when the conveyor mechanism and the ink-jet head are located at the recording position and at which a jammed recording medium jammed between the ejection surface and the conveyor mechanism is allowed to be removed by a user; and
a detecting device configured to detect an occurrence of a jam of the recording medium between the ink-jet head and the conveyor mechanism.

8. The ink-jet recording apparatus according to claim 7, wherein the controller is configured to control the relative movement mechanism such that a third motion is conducted concurrently with the first motion and the second motion where a condition, as the prescribed condition, that the detecting device detects the occurrence of the jam of the recording medium is satisfied, the third motion being a motion in which said at least one of the conveyor mechanism and the ink-jet head is moved relative to each other such that the conveyor mechanism and the ink-jet head are located at the medium removal position from the recording position.

9. The ink-jet recording apparatus according to claim 7, wherein the controller is configured to control the relative movement mechanism such that a third motion is conducted prior to the first motion and the second motion where a condition, as the prescribed condition, that the detecting device detects the occurrence of the jam of the recording medium is satisfied, the third motion being a motion in which said at least one of the conveyor mechanism and the ink-jet head is moved relative to each other such that the conveyor mechanism and the ink-jet head are located at the medium removal position from the recording position.

10. The ink-jet recording apparatus according to claim 1, wherein the conveyor mechanism has an adhesion device configured to cause the recording medium to adhere to the conveyor surface.

11. The ink-jet recording apparatus according to claim 10, wherein the controller is configured to control the adhesion device to be placed in its operating state in the second motion.
